(19) United States
(12) Patent Application Publication
(10) Pub. No.: US 2013/0134288 A1
(43) Pub. Date: May 30, 2013

(54) SPRING POST BOX HOLDER FOR RECEIVING A MAILBOX AND POST ARRANGEMENT FOR ABSORBING IMPACTS, E.G., FROM SNOW, SLUSH, ICE AND WATER THROWN FROM A PLOWBLADE

(71) Applicant: Michael WEBBER, Sherman, CT (US)

(72) Inventor: Michael WEBBER, Sherman, CT (US)

(21) Appl. No.: 13/306,221

(22) Filed: Nov. 29, 2011

(51) Int. Cl. F16M 11/04

(52) U.S. Cl. 248/622

(57) ABSTRACT

A spring post box holder features an elastic assembly (EA), a lower unit assembly (LUA) and an upper unit assembly (UUA). The EA expands and contracts in response to a force. The LUA mounts to the ground and has a square tube with four walls and a wall to couple to the EA. The UUA mounts to a mailbox post on one end and has a post pocket retainer (PPR) with a front, back and opposing side walls. The UUA mounts to the LUA via the elastic assembly member, and flexes vis-a-vis the LUA in response to the force. The front, back and opposing side walls sit within the four walls of the square tube allowing a flexing of the UUA vis-a-vis the LUA in side-to-side directions and a front-to-back direction and a returning and seating of the UUA back to an original return position vis-à-vis to the LUA in response to the force, and preventing flexing of the UUA vis-a-vis to the LUA in a back-to-front direction.

### BACKGROUND OF THE INVENTION

1. Field of Invention

This invention relates to a device for holding a post of a mailbox, and more particularly to a device for holding a post of a mailbox that is designed to absorb impacts from snow, slush, ice and water thrown from a plowblade when streets are being cleaned in the winter time, as well as impact from vandalism.

2. Description of Related Art

Devices and arrangements designed to absorb impacts from snow, slush, ice and water thrown from a plowblade when streets are being cleaned in the winter time, as well as impact from vandalism, are known in the art. One such device is disclosed in U.S. Pat. No. 7,559,457, which issued to the inventor of the present application.

### BRIEF DESCRIPTION OF THE DRAWING

The drawing includes the following Figures that are not necessarily drawn to scale:

FIG. 1 shows various views of a spring post box holder according to some embodiments of the present invention, including FIG. 1a(1) that is a top perspective view of the spring post box holder mounted above the ground; FIG. 1a(2) that is a top view of the spring post box holder mounted substantially below the ground; FIG. 1b that is a side partial cross sectional view of the spring post box holder; FIG. 1c that is a front partial cross sectional view of the spring post box holder; and FIG. 1d that is a back view of the spring post box holder.

FIG. 2 shows various views of an upper unit assembly that forms part of the spring post box holder shown in FIG. 1 according to some embodiments of the present invention, including FIG. 2a that is a bottom perspective view of the upper unit assembly; FIG. 2b that is a front partial cross sectional view of the upper unit assembly in the direction of arrows labeled 2b shown in FIG. 2a; FIG. 2c that is a side view of the upper unit assembly shown in FIG. 2a in the direction of arrow labeled 2c shown in FIG. 2b; and FIG. 2d that is a plan view of the upper unit assembly in the direction of arrow labeled 2d shown in FIG. 2a.

FIG. 3 shows various views of post pocket retainers that may form part of the upper unit assembly shown in FIG. 2 according to some embodiments of the present invention, including FIG. 3a that is a perspective view of one such post pocket retainer; and including FIGS. 3b-3d, where 3b is a side view of another such post pocket retainer consistent and similar to that shown in FIG. 3a; where FIG. 3c is a side view of the post pocket retainer shown in FIG. 3b in the direction of arrow labeled 3c shown in FIG. 3b; and where FIG. 3d that is a plan view of the post pocket retainer shown in FIG. 3b in the direction of arrow labeled 3d shown in FIG. 3b.

FIG. 4 shows various views of an upper plate that forms part of the upper unit assembly shown in FIG. 2 according to some embodiments of the present invention, including FIG. 4a that is a perspective view of the upper plate; FIG. 4b that is a plan view of the upper shown in FIG. 4a; and FIG. 4c that is a side view of the upper plate shown in FIG. 4a.

FIG. 5 shows various views of a 4″ by 4″ substantially square tubular pipe that forms part of the upper unit assembly shown in FIG. 2 according to some embodiments of the present invention, including FIG. 5a that is a perspective view of the 4″ by 4″ substantially square tubular pipe; FIGS. 5b1 and 4b2 that are side views of the 4″ by 4″ substantially square tubular pipe in FIG. 5a; and FIG. 5c that is a top view of the 4″ by 4″ substantially square tubular pipe shown in FIG. 5a.

FIG. 6 shows various views of a lower unit assembly that forms part of the spring post box holder shown in FIG. 1 according to some embodiments of the present invention, including FIG. 6a that is a top perspective view of lower unit assembly; FIG. 6b that is a front view of the lower unit assembly shown in FIG. 6a in the direction of arrow labeled 6b shown in FIG. 6a; FIG. 6c that is a cross sectional view along lines A-A in FIG. 6b of the lower unit assembly shown in FIG. 6b; and FIG. 6d that is a top view of the lower unit assembly shown in FIG. 6a.

FIG. 7 shows various views of the 2.5″ by 2.5″ substantially square tubular pipe that form part of the lower unit assembly shown in FIG. 6 according to some embodiments of the present invention, including FIG. 7a that is a top perspective view of the 2.5″ by 2.5″ pipe; FIG. 7b that is a side view of the 2.5″ by 2.5″ substantially square tubular pipe shown in FIG. 7a in the direction of arrow labeled 7b shown in FIG. 7a; and FIG. 7c that is a top view of the 2.5″ by 2.5″ substantially square tubular pipe shown in FIG. 7a.

FIG. 8 shows a perspective view of the lower plate that forms part of the lower unit assembly shown in FIG. 6 according to some embodiments of the present invention.

### BRIEF SUMMARY OF THE INVENTION

According to some embodiments of the present invention, the present invention features a new and unique spring post box holder having in combination an elastic assembly, a lower unit assembly and an upper unit assembly.

The elastic assembly is configured to expand and contract in response to an applied force, including impacts from snow, slush, ice and water thrown from a plowblade when streets are being cleaned in the winter time, as well as impact from vandalism, that hit a mailbox post and/or a mailbox.

The lower unit assembly is configured to mount to the ground or some suitable support or foundation, having a substantially square tube with four walls, at least one wall configured to couple to the elastic assembly.

The upper unit assembly is configured to be mounted to the post of the mailbox on one end and also configured with a post pocket retainer with a front wall, a back wall and opposing side walls. The upper unit assembly is configured to mount to the lower unit assembly being coupled together via the elastic member, and is also configured to flex in relation to the lower unit assembly in response to the applied force. The front wall, back wall and opposing side walls of the post pocket retainer are configured to sit within the four walls of the substantially square tube of the lower unit assembly, to allow a controlled flexing of the upper unit assembly in relation to the lower unit assembly in side-to-side directions and a front-to-back direction and a returning and seating of the upper unit assembly back to an original return position in relation to the lower unit assembly in response to the force, and to prevent substantially a flexing of the upper unit assembly in relation to the lower unit assembly in a back-to-front direction.

According to some embodiments of the present invention, the spring post box holder may include one or more of the following features:

The back wall may include an angled portion configured to extend into the substantially square tube of the lower unit assembly further than the front wall and the opposing side walls and to act as a stop to prevent the flexing of the upper unit assembly in relation to the lower unit assembly in the back-to-front direction by binding against the inside of a corresponding wall of the substantially square tube of the lower unit assembly.

The angled portion may be configured as a triangular.

The angled portion may be configured with an angle of about 80°.

The front wall may include an inwardly bent angled portion configured to extend into the substantially square tube of the lower unit assembly further than the front wall and the opposing side walls and to allow the controlled flexing of the upper unit assembly in relation to the lower unit assembly in the front-to-back direction. The inwardly bent angled portion may also be configured as a trapezoid, configured with an angle of about 80°, and configured with an angle of about 40° in relation to its base portion.

The post pocket retainer and the substantially square tube of the lower unit assembly may be dimensioned so that the post pocket retainer is received inside the substantially square tube with a substantially tight spacing or clearance, including a dimension of about 1/16″.

The opposing side walls may be configured with an outwardly tapered rim surface to allow flexing in the side-to-side directions.

The upper unit assembly includes an upper plate configured with the post pocket retainer affixed thereon to mount to the lower unit assembly, e.g., including being configured to rest on top surfaces of the walls of the lower unit assembly 14.

The front wall may have an angled portion configured to extend into the substantially square tube of the lower unit assembly further than opposing side walls and to act as at least a partial stop to reduce or substantially prevent the flexing of the upper unit assembly in relation to the lower unit assembly in the front-to-back direction by binding against the inside of a corresponding wall of the substantially square tube of the lower unit assembly.

The upper unit assembly may be configured with a corresponding substantially square tube with four corresponding walls, and the four corresponding walls of the corresponding substantially square tube of the upper unit assembly are configured to extend around and partially overlap the four walls of the substantially square tube of the lower unit assembly.

Corresponding back and opposing side walls of the upper unit assembly may be configured to contact back and opposing side walls of the lower unit assembly when the upper unit assembly is flexed in relation to the lower unit assembly so as to stop the flexing in the side-to-side directions and the front-to-back direction, or so as to allow the controlled flexing of the upper unit assembly in relation to the lower unit assembly in the side-to-side directions up to 45° and within a 180° circumference.

The elastic assembly may include a bolt coupled to a spring, and the substantially square tube of the lower unit assembly is configured with openings to receive the bolt and the spring on one end of the spring assembly. The elastic assembly may also include a pin that is configured to couple to the spring on the other end, and the upper unit assembly comprises an upper mounting plate that is configured to receive and engage the pin, including with a nut.

The corresponding walls of the upper unit assembly may be configured with fastener openings formed to receive fasteners, including screws or nails, to couple the post into the upper unit assembly.

### Post Pocket Retainer

In summary, the “Post Pocket Retainer” according to some embodiments of the present invention features a simple pivoting design, due to its overall dimension, angled cuts and bend. The dimensions and outer clearance allows a controlled flexibility inside the “Lower Unit Assembly”. This will also allow a so-called perfect alignment for the “Upper Unit Assembly” to seat back to the original return position.

The “Post Pocket Retainer” has four purposes as follow:

1. Pivot Point (Fulcrum) (combined with the bottom of the “Upper Plate” and the upper edge of the “Lower 2.5″×2.5″ Pipe”),

2. Realigning Angles and Shape (slides inside “Lower Tube” directing the return position),

3. Flex Stop (combined with bottom edge of the “4″×4″ Pipe” @45 degrees), and

4. Forward Stop (prevents from flexing forward, by binding against the inside of the “Lower Tube”).

The unique square-tube-inside-square-tube-design allows for a so-called perfect return position. The cut and bent angles allow the direction of which it can flex and guides the “Upper Unit Assembly” back to the original erect position. The straight triangular piece (opposite from the bent angle), works as a stop, this piece prevents any flexing forward (towards the street).

The “Post Pocket Retainer” design allows the “Upper Unit Assembly” to flex up to about 45 degrees and within about a 180 degree circumference.

### BEST MODE OF THE INVENTION

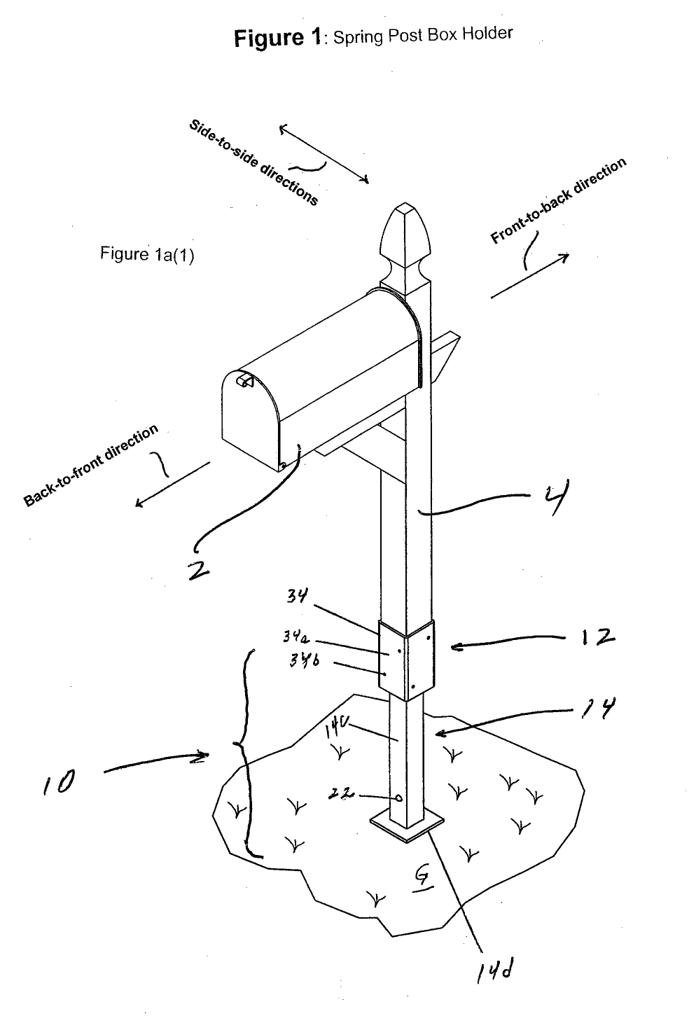

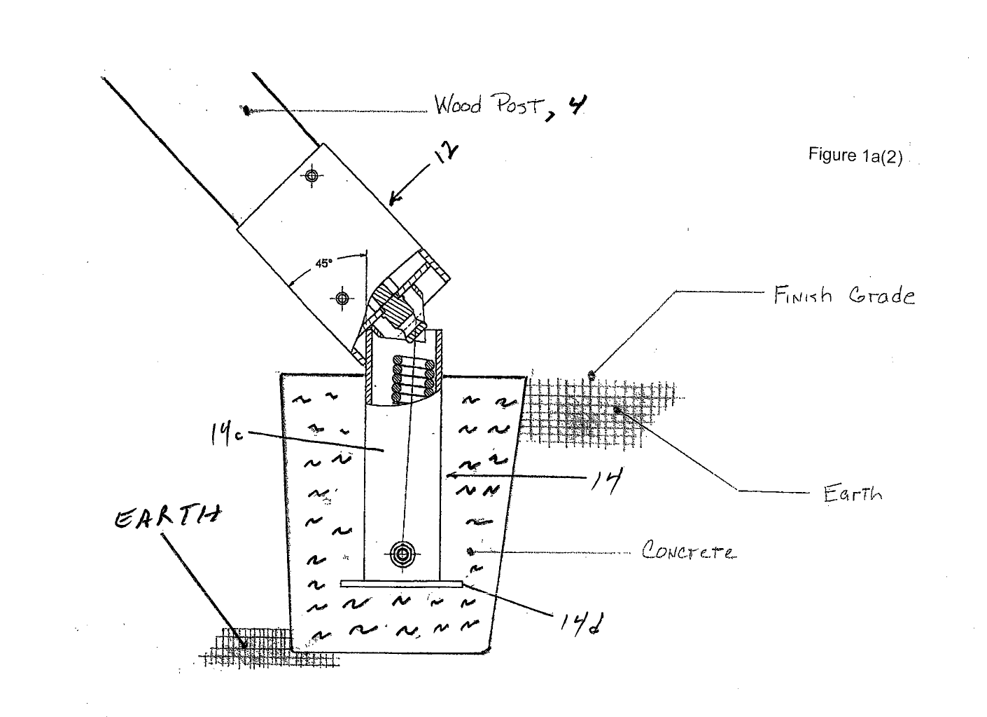

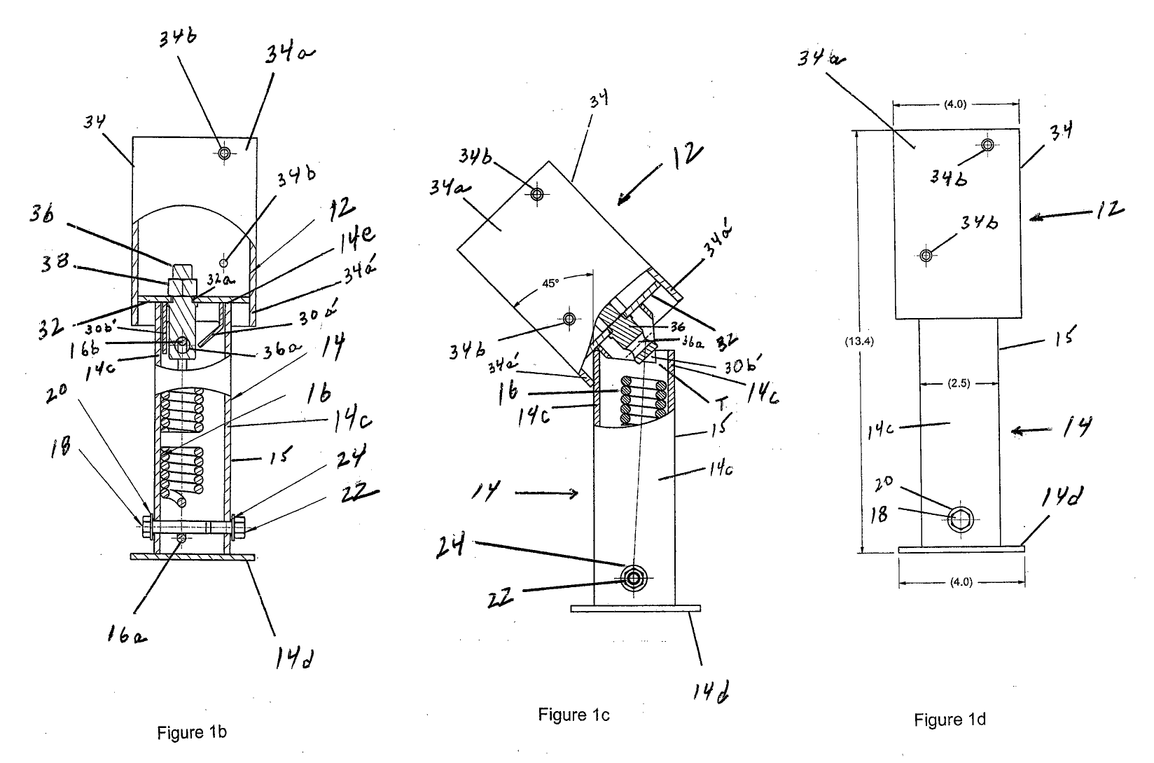

### FIG. 1: The Spring Box Post Holder 10

FIG. 1 show a new and unique spring box post holder 10 according to some embodiments of the present invention, which includes an upper unit assembly generally indicated as 12 and a lower unit assembly generally indicated 14.

As shown in FIG. 1a(1), a post 4 having a mailbox affixed thereto may be coupled into the upper unit assembly 12 consistent with that set forth below. The upper unit assembly 12 has a substantially square tubular shape, as shown. The lower unit assembly 14 is configured to mount to the ground or some suitable support or foundation, generally indicated as G. For the purpose of describing the present invention, in FIG. 1a(1) the lower unit assembly 14 is shown substantially above the ground, while in FIG. 1a(2) the lower unit assembly 14 is shown substantially below the ground in concrete. Typically, the lower unit assembly 14 would be mounted substantially underground with only enough clearance above the ground to allow for the flexing or tilting as shown in FIG. 1a(2) consistent with that set forth herein. (The details of upper and lower unit assemblies 12, 14 shown in FIG. 1a(b) are shown and described herein, e.g., in relation to FIGS. 1b and 1c.) The scope of the invention is not intended to be limited to the manner in which the lower unit assembly 14 is mounted to the ground or some suitable support or foundation, or the amount of the lower unit assembly 14 that is above or below the ground. The lower unit assembly 14 has a corresponding substantially square tubular shape, as shown. The spring box post holder 10 is designed to absorb impacts from applied forces, such as snow, slush, ice and water thrown from a plowblade when streets are being cleaned in the winter time, as well as impact from vandalism, that hit the post 4 and/or the mailbox 2.

By way of example, FIGS. 1b, 1c and 1d show in further detail the spring post box holder 10 according to some embodiments of the present invention. The spring post box holder 10 includes the combination of the upper unit assembly 12, the lower unit assembly 14 together with an elastic assembly. The combination is configured to respond to the applied force and allow a controlled flexing of the upper unit assembly 12 in relation to the lower unit assembly 14 in side-to-side directions and a front-to-back direction and a returning and seating of the upper unit assembly 12 back to an original return position in relation to the lower unit assembly 14 in response to the force, and to prevent substantially a flexing of the upper unit assembly 12 in relation to the lower unit assembly 14 in a back-to-front direction, consistent with that set forth herein. In FIG. 1a(1), the front of the mailbox is understood to be where the mail is removed, and is typically facing the road for delivery by the postal service. FIG. 1a shows the front-to-back direction, the back-to-front direction and the side-to-side directions, the controlled flexing enables the upper unit assembly 12 to flex in relation to the lower unit assembly 14 from both side-to-side and front-to-back directions so as to minimize damage that might otherwise be caused to the post 4 and/or the mailbox 2, e.g., including the mailbox 2 being separated or detached from the post 4. The returning and seating of the upper unit assembly 12 back to the original return position in relation to the lower unit assembly 14 is understood to be a so-called non-tilted position, consistent with that shown, e.g., in FIG. 1a(1), 1b, 1d, in contrast, to the tilted position shown in FIG. 1c.

### The Elastic Assembly

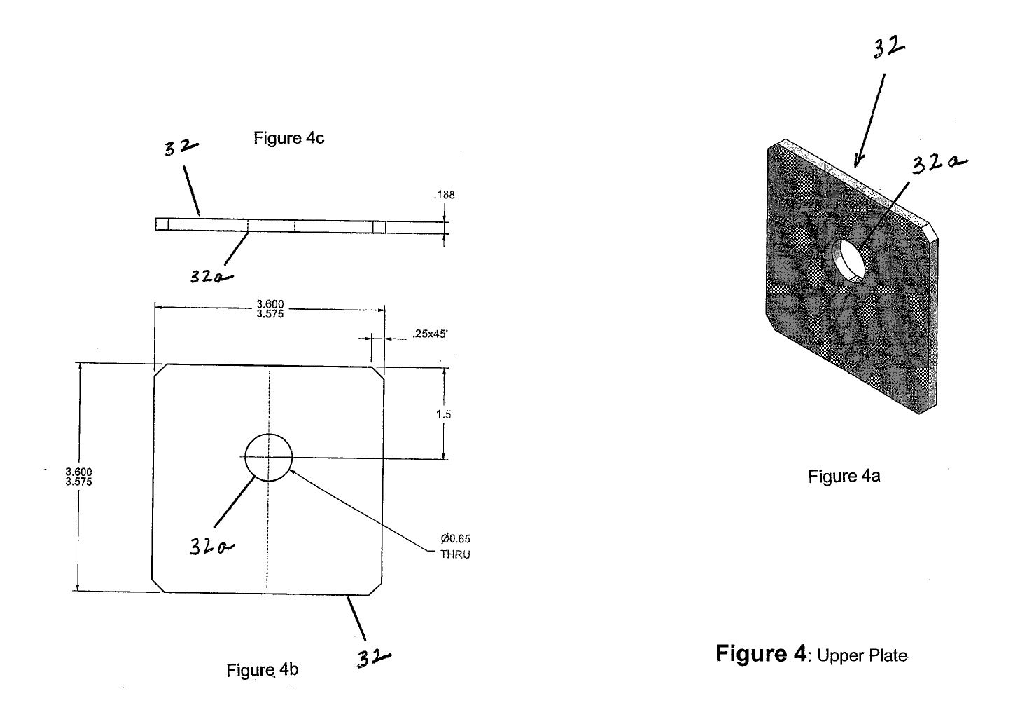

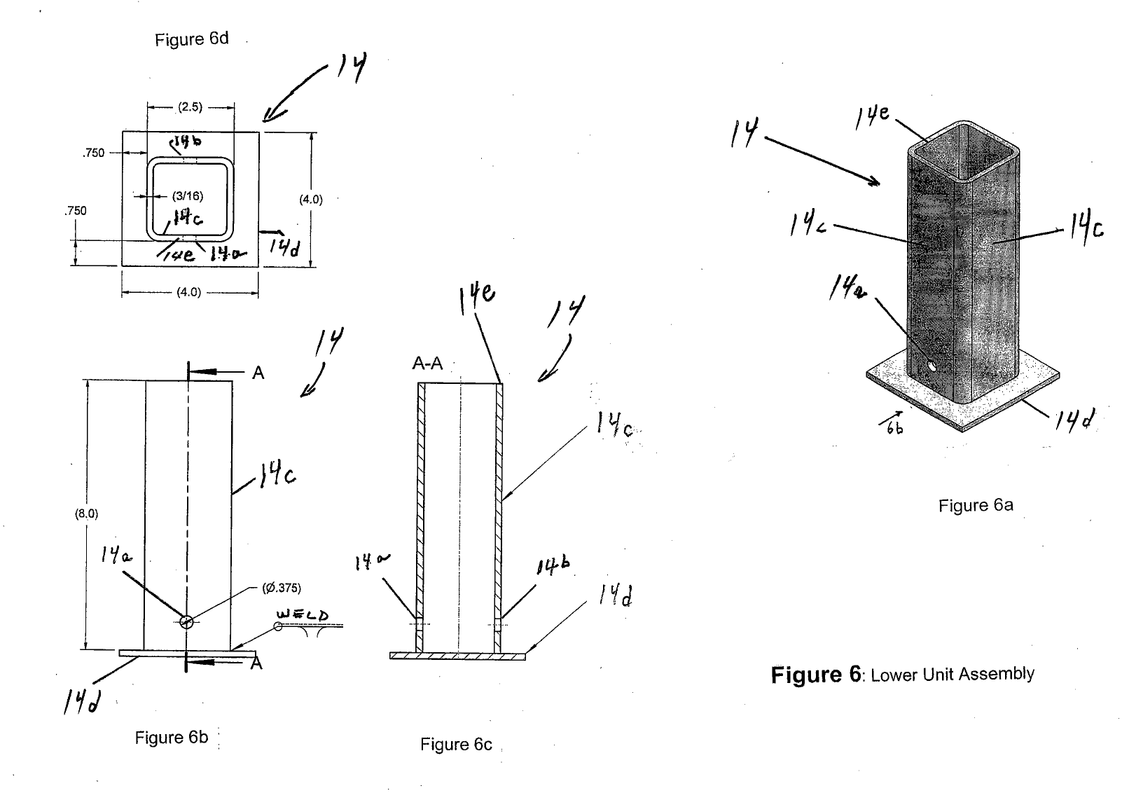

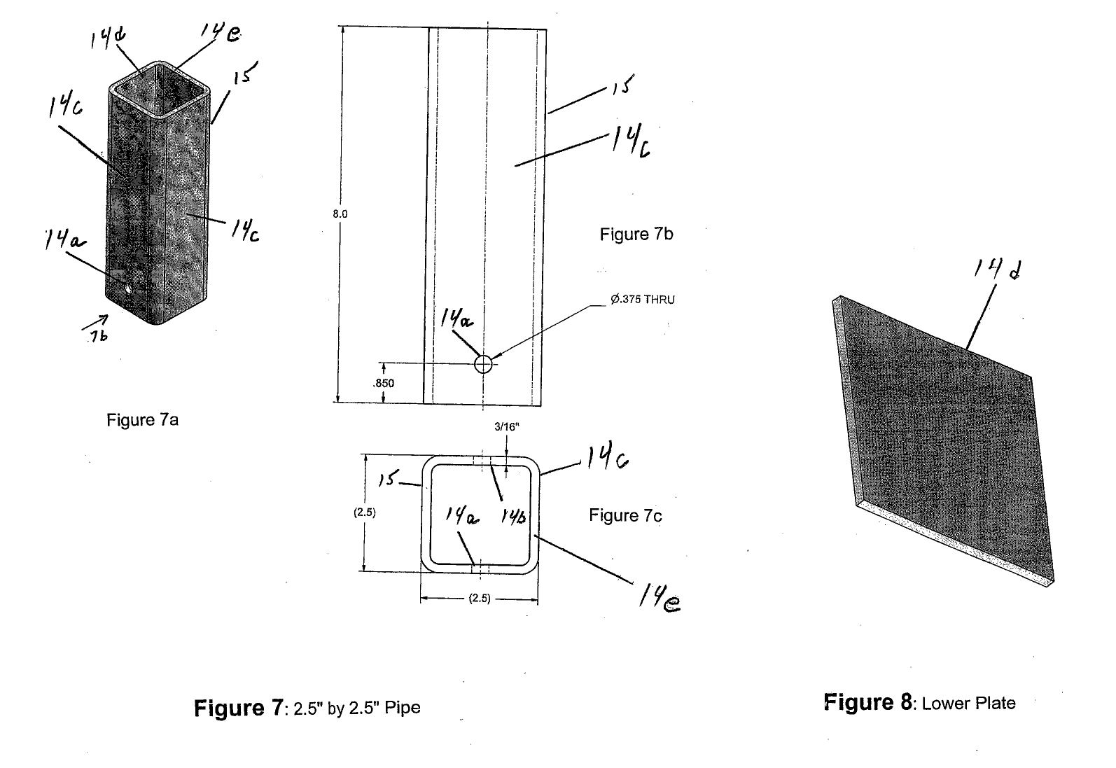

As shown by way of example in FIGS. 1b and 1c, according to some embodiments of the present invention the elastic assembly may include a spring 16, a nut 18, a washer 20, a bolt 22, and an O-ring 24 configured in combination to couple the spring 16 to the lower unit assembly 12 on one end. As best shown in FIG. 1b, the bolt 22 passes through two apertures 14a, 14b (see FIGS. 6 and 7) in tubular walls 14c of the lower unit assembly 14, and one end 16a of the spring 16 is coupled to the bolt 22. The elastic assembly also includes a combination of a pin 36 and a nut 38 affixed to an upper plate 32 of the upper unit assembly 12 configured in combination to couple the spring 16 to the upper unit assembly 12 on the other end. As best shown in FIG. 1b, the pin 36 passes through an aperture 32a (see FIG. 4) in the upper plate 32, a nut 38 fastens the pin 36 to the upper plate 32, and the other end 16b of the spring 16 is coupled through an aperture 36a formed in the lower end of the pin 36.

The elastic assembly, including the spring 16, is configured to expand and contract in response to an applied force, e.g., caused by impacts from snow, slush, ice and water thrown from a plowblade when streets are being cleaned in the winter time, as well as impact from vandalism, that hit the post 4 and/or the mailbox 2. The expansion and contraction of the spring 16 allows the upper unit assembly 12 to flex in relation to the lower unit assembly 14, consistent with that set forth herein. By way of example, the elastic assembly is described in relation to using a spring such as element 16; however, embodiments are envisioned using other types or kinds of elastic members either now known or later developed in the future. By way of example, the elastic assembly is described in relation to using the combination of the nut 18, washer 20, bolt 22, and O-ring 24 to couple the spring 16 to the lower unit assembly 14 on the one end; however, embodiments are envisioned using other types or kinds of mechanical combinations either now known or later developed in the future to couple the spring 16 to the lower unit assembly 14 on the one end within the spirit of the present invention. For example, embodiments are envisioned in which the spring 16 is coupled to one tubular wall of the lower unit assembly 14. By way of example, the elastic assembly is described in relation to using the combination of the pin 36 and nut 38 affixed to the upper plate 32 to couple the spring 16 to the upper unit assembly 12; however, embodiments are envisioned using other types or kinds of mechanical combinations either now known or later developed in the future to couple the spring 16 to the upper unit assembly 12 on the other end within the spirit of the present invention.

### The Upper Unit Assembly 12

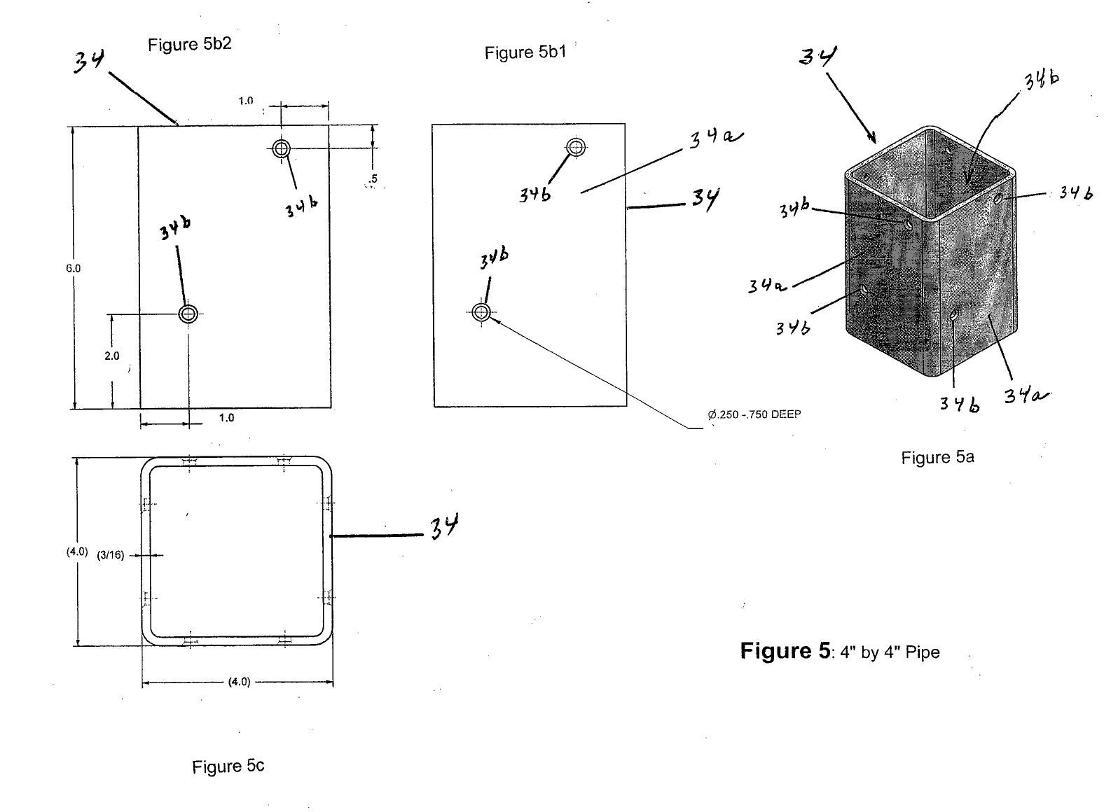

As shown by way of example in FIGS. 1b, 1c, and 2-5, according to some embodiments of the present invention, the upper unit assembly 12 may be configured as a 4″ by 4″ substantially square tube or pipe 34 having four tubular walls 34a forming an aperture 34b configured to receive and mount the post 4. Each tubular wall 34a is configured with at least one aperture 34b formed therein configured to receive a fastener, e.g., a nail or a screw, to securely affix the post 4 within the aperture 34b. The upper unit assembly 12 is configured to mount to the lower unit assembly 14 being coupled together via the elastic member, consistent with that described above. By way of example, the upper unit assembly 12 may include an upper plate 32 (FIGS. 1, 2 and 4) configured with a post pocket retainer 30 affixed thereon (e.g., by welding) to mount to the lower unit assembly 14. According to some embodiments of the present invention, the upper plate 32 is configured to rest on top surfaces 14e (FIGS. 6-7) of the walls 14c of the lower unit assembly 14, as best shown in FIG. 1b.

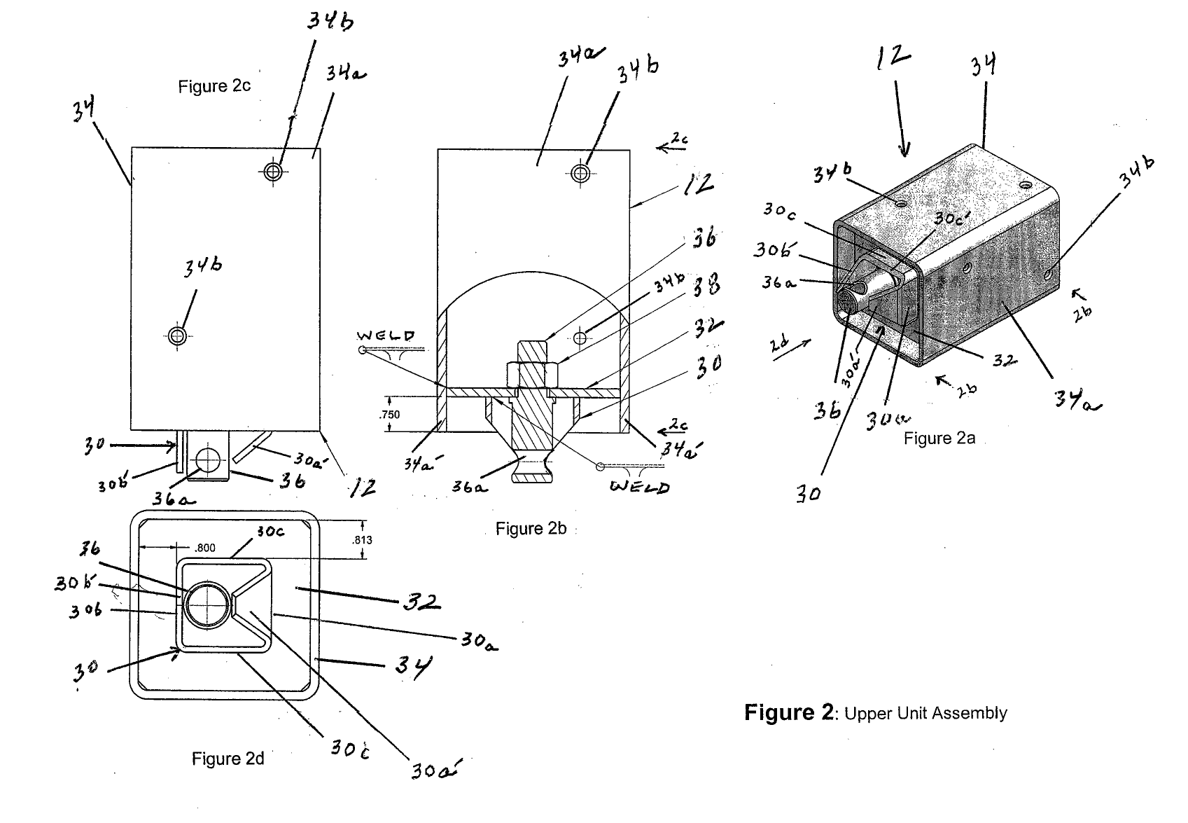

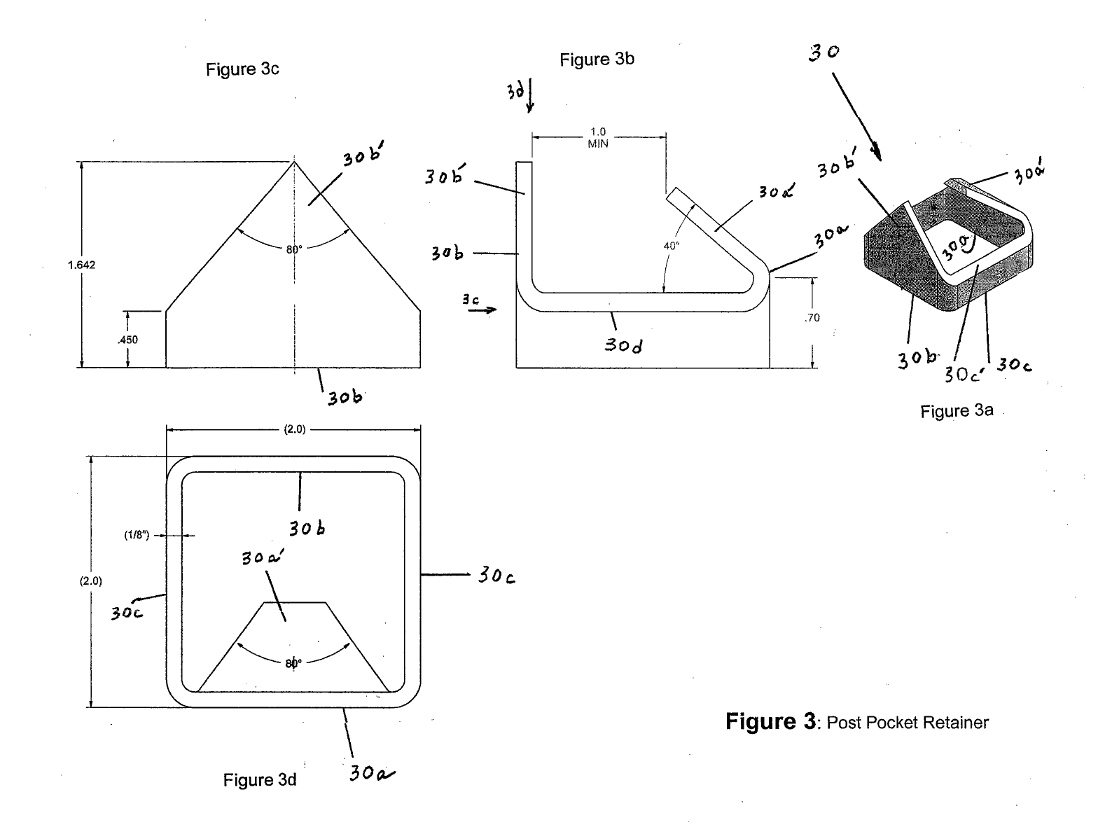

The post pocket retainer 30 (see FIGS. 2 and 3) is configured with a front wall 30a, a back wall 30b and opposing side walls 30c. The front wall 30a, back wall 30b and opposing side walls 30c of the post pocket retainer 30 are configured to sit within four tubular walls 14c of a substantially square pipe or tube 15 of the lower unit assembly 14, to allow the controlled flexing of the upper unit assembly 12 in relation to the lower unit assembly 14 in the side-to-side directions and the front-to-back direction and the returning and seating of the upper unit assembly 12 back to an original return position in relation to the lower unit assembly 14 in response to the force, and to prevent substantially the flexing of the upper unit assembly 12 in relation to the lower unit assembly 14 in the back-to-front direction. (See FIG. 1a(1) for an indication of the front-to-back direction, the back-to-front direction and the side-to-side directions.)

According to some embodiments of the present invention, the back wall 30b may include an angled portion 30b′ configured to extend into the substantially square tube 15 of the lower unit assembly 14 further than the front wall 30a and the opposing side walls 30c and to act as a stop to prevent the flexing of the upper unit assembly 12 in relation to the lower unit assembly 14 in the back-to-front direction (see FIG. 1a(1)) by binding against the inside of a corresponding wall 14c of the substantially square tube 15 of the lower unit assembly 14, as best shown in FIG. 1b. By way of example, FIG. 3 shown one embodiment of the post pocket retainer having dimensions, shown in inches, where the back wall 30b has a dimension of about 1.642 inches, and the angled portion has a dimension of 1.192 inches (i.e., 1.642-0.450). FIG. 1c shows the angled portion 30b′ position when the upper unit assembly is flexed leftwardly (looking into FIG. 1c) a full 45°, such that the tip T of the angled portion 30b′ is configured so as not to contact the side wall 14c on the right side (looking into FIG. 1c).

The angled portion 30b′ may be configured as a triangular, as shown in FIG. 3c, although the scope of the invention is intended to include other geometric shapes, including a trapezoid, a semi-circle, etc., in order to achieve the desired flexing and tilting functionality

The angled portion 30b′ may be configured with an angle of about 80° as shown in FIG. 3c, although the scope of the invention is intended to include other angles in order to achieve the desired flexing and tilting functionality.

The front wall 30a may include an inwardly bent angled portion 30a′ as shown in FIG. 3d configured to extend into the substantially square tube 15 of the lower unit assembly 14 further than the front wall 30a and the opposing side walls 30c as shown in FIG. 1b (see also FIG. 2a) and to allow the controlled flexing of the upper unit assembly 12 in relation to the lower unit assembly 14 in the front-to-back direction (see FIG. 1a(1)). The inwardly bent angled portion 30a may also be configured as a trapezoid, as shown, configured with an angle of about 80° as shown in FIG. 3d, and configured with an angle of about 40° in relation to its base portion 30d. In contrast to the angled portion 30b′ of the back wall 30b, the inwardly bent angled portion 30a′ is bent to allow flexing in the front-to-back direction. Moreover, the inwardly bent angled portion 30a′ is bent at an angle so as to avoid hitting the upper portion of the pin 36.

The post pocket retainer 30 and the substantially square tube 15 of the lower unit assembly 14 may be dimensioned so that the post pocket retainer 30 is received inside the substantially square tube 15 with a substantially tight spacing or clearance, including a dimension of about 1/16″, as best shown in FIG. 1b.

The opposing side walls 30c of the post pocket retainer 30 may be configured with an outwardly tapered rim surface 30c′ to allow the flexing in the side-to-side directions, as best shown in FIG. 3a (see also FIG. 2a).

The four corresponding walls 34a of the corresponding substantially square tube 34 of the upper unit assembly 12 may be configured to extend around and partially overlap the four walls 14c of the substantially square tube 15 of the lower unit assembly 14, as best shown in FIGS. 1b and 1c. In particular, and by way of example, FIG. 2b shows the upper plate 32 arranged in the upper unit assembly 12 so as to leave 0.75 inch extending wall portions 34a′ of the four corresponding walls 34a. In operation, as best shown in FIG. 1 c, the extending wall portions 34a′ of corresponding back and opposing side walls 34a of the upper unit assembly 12 may be configured to contact the outside of back and opposing side walls 14c of the lower unit assembly 14 when the upper unit assembly 12 is flexed in relation to the lower unit assembly 14 so as to stop the flexing in the side-to-side directions and the front-to-back direction, as shown in FIG. 1c, and/or so as to allow the controlled flexing of the upper unit assembly 12 in relation to the lower unit assembly 14 in the side-to-side directions up to 45° on each side and within a 180° circumference (including the back and side-to-side directions).

FIGS. 1a(1) and 1a(2)shows the spring box post holder 10 and the post 4 having respective lengths and a relationship between the respective lengths. However, the scope of the invention is not intended to be limited to the respective lengths of the spring box post holder 10 and the post 4 or the relationship between the respective lengths. For example, embodiments are envisioned in which the length of the spring box post holder 10 is greater than the length of the post 4; and embodiments are also envisioned in which the length of the spring box post holder 10 is less than, or even equal to, the length of the post 4.

In FIGS. 1a(1) and 1a(2), the mailbox 2 and the post 4, and the structural relationship between the mailbox 2 and the post 4, are shown by way of example. Mailboxes and posts, and structural relationships between such mailboxes and posts, are known in the art, and the scope of the invention is not intended to be limited to the same. For example, embodiments are envisioned having other types or kinds mailboxes and posts, and structural relationships between such mailboxes and posts, within the spirit of the present invention.

### The Dimensions

By way of example, FIGS. 1-8 include various dimensions in inches for different parts for the embodiment shown therein. However, the scope of the inventions is not intended to be limited to the exact dimensions shown therein. Moreover, the scope of the inventions is not intended to be limited to any particular dimensions for any particular parts shown in FIGS. 1-8. For example, the scope of the invention is intended to include embodiments having other dimensions for the parts shown in FIGS. 1-8, as well as embodiments having other dimensional relationships between the parts shown in FIGS. 1-8. In particular, embodiments are envisioned having dimensions that are scaled upwardly or downwardly but having the substantially same or similar ratio as the dimensions shown in FIGS. 1-8.

### The Welds

In the Figures, various components are shown by way of example to be welded together, although the scope of the invention is intended to include other types or kinds of connection techniques either now known or later developed in the future.

### The Scope of the Invention

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

I claim:

1. A spring post box holder comprising:
an elastic assembly configured to expand and contract in response to an applied force;
a lower unit assembly configured to mount to the ground or some suitable support or foundation, having a substantially square tube with four walls, at least one wall configured to couple to the elastic assembly; and
an upper unit assembly configured to mount to a post of a mailbox on one end, having a post pocket retainer with a front wall, a back wall and opposing side walls, the upper unit assembly configured to mount to the lower unit assembly and being coupled together via the elastic member, the upper unit assembly configured to flex in relation to the lower unit assembly in response to the applied force, and the front wall, back wall and opposing side walls of the post pocket retainer configured to sit within the four walls of the substantially square tube of the lower unit assembly, to allow a controlled flexing of the upper unit assembly in relation to the lower unit assembly in side-to-side directions and a front-to-back direction and a returning and seating of the upper unit assembly back to an original return position in relation to the lower unit assembly in response to the force, and to prevent substantially a flexing of the upper unit assembly in relation to the lower unit assembly in a back-to-front direction.

2. A spring post box holder according to claim 1, wherein the back wall has an angled portion configured to extend into the substantially square tube of the lower unit assembly further than the front wall and the opposing side walls and to act as a stop to prevent the flexing of the upper unit assembly in relation to the lower unit assembly in the back-to-front direction by binding against the inside of a corresponding wall of the substantially square tube of the lower unit assembly.

3. A spring post box holder according to claim 2, wherein the angled portion is configured as a triangular.

4. A spring post box holder according to claim 2, wherein the angled portion is configured with an angle of about 80°.

5. A spring post box holder according to claim 1, wherein the front wall has an inwardly bent angled portion configured to extend into the substantially square tube of the lower unit assembly further than the front wall and the opposing side walls and to allow the controlled flexing of the upper unit assembly in relation to the lower unit assembly in the front-to-back direction.

6. A spring post box holder according to claim 5, wherein the inwardly bent angled portion is configured as a trapezoid.

7. A spring post box holder according to claim 5, wherein the inwardly bent angled portion is configured with an angle of about 80°.

8. A spring post box holder according to claim 1, wherein the inwardly bent angled portion is configured with an angle of about 40° in relation to its base portion.

9. A spring post box holder according to claim 1, wherein the post pocket retainer and the substantially square tube of the lower unit assembly are dimensioned so that the post pocket retainer is received inside the substantially square tube with a substantially tight spacing or clearance, including a dimension of about 1/16″.

10. A spring post box holder according to claim 1, wherein the opposing side walls are configured with an outwardly tapered rim surface to allow flexing in the side-to-side directions.

11. A spring post box holder according to claim 1, wherein the upper unit assembly comprises an upper plate configured with the post pocket retainer affixed thereon to mount to the lower unit assembly, including where the upper plate is configured to rest on top surfaces of the walls of the lower unit assembly.

12. A spring post box holder according to claim 1, wherein the front wall has an angled portion configured to extend further into the substantially square tube of the lower unit assembly than opposing side walls and to act as at least a partial stop to reduce or substantially prevent the flexing of the upper unit assembly in relation to the lower unit assembly in the front-to-back direction by binding against the inside of a corresponding wall of the substantially square tube of the lower unit assembly.

13. A spring post box holder according to claim 1, wherein the upper unit assembly is configured with a corresponding substantially square tube with four corresponding walls, and the four corresponding walls of the corresponding substantially square tube of the upper unit assembly are configured to extend around and partially overlap the four walls of the substantially square tube of the lower unit assembly.

14. A spring post box holder according to claim 13, wherein corresponding back and opposing side walls of the upper unit assembly are configured to contact back and opposing side walls of the lower unit assembly when the upper unit assembly is flexed in relation to the lower unit assembly so as to stop the flexing in the side-to-side directions and the front-to-back direction.

15. A spring post box holder according to claim 13, wherein corresponding back and opposing side walls of the upper unit assembly are configured to contact back and opposing side walls of the lower unit assembly when the upper unit assembly is flexed in relation to the lower unit assembly so as to allow the controlled flexing of the upper unit assembly in relation to the lower unit assembly in the side-to-side directions up to 45° and within a 180° circumference.

16. A spring post box holder according to claim 1, wherein the elastic assembly comprises a bolt coupled to a spring, and the substantially square tube of the lower unit assembly is configured with openings to receive the bolt and the spring on one end of the spring assembly.

17. A spring post box holder according to claim 16, wherein the elastic assembly comprises a pin that is configured to couple to the spring on the other end, and the upper unit assembly comprises an upper mounting plate that is configured to receive and engage the pin, including with a nut.

18. A spring post box holder according to claim 13, wherein the corresponding walls of the upper unit assembly are configured with fastener openings formed to receive fasteners, including screws or nails, to couple the post into the upper unit assembly

19. A spring post box holder comprising:
an elastic assembly configured to expand and contract in response to an applied force;
a lower unit assembly configured to mount to the ground or some suitable support or foundation, having a substantially square tube with four walls, at least one wall configured to couple to the elastic assembly; and
an upper unit assembly configured to mount to a post of a mailbox on one end, having a corresponding substantially square tube with four corresponding walls, having a post pocket retainer with a front wall, a back wall and opposing side walls, the upper unit assembly configured to couple to the lower unit assembly via the elastic member, the upper unit assembly configured to flex in relation to the lower unit assembly in response to the applied force, the four corresponding walls of the corresponding substantially square tube of the upper unit assembly configured to extend around and partially overlap the four walls of the substantially square tube of the lower unit assembly, and the front wall, back wall and opposing side walls of the post pocket retainer configured to sit within the four walls of the substantially square tube of the lower unit assembly, to allow a controlled flexing of the upper unit assembly in relation to the lower unit assembly in side-to-side directions and a front-to-back direction and a returning and seating of the upper unit assembly back to an original return position in relation to the lower unit assembly in response to the force, and to prevent substantially a flexing of the upper unit assembly in relation to the lower unit assembly in a back-to-front direction.
